(19) United States
(12) Patent Application Publication
(10) Pub. No.: US 2025/0001223 A1
(43) Pub. Date: Jan. 2, 2025

(54) FALL PROTECTION LOCKING SYSTEM

(71) Applicant: Honeywell Safety Products USA Inc., Charlotte, NC (US)

(72) Inventors: Moutasem Yousef, Brno (CZ); Jan Macka, Brno (CZ); Vaclav Hruza, Brno (CZ); Tanguy Prevot, Nebovidy (CZ)

(21) Appl. No.: 18/217,042

(22) Filed: Jun. 30, 2023

(51) Int. Cl. A62B 35/00; A62B 35/04

(52) U.S. Cl. CPC A62B 35/0037; A62B 35/005; A62B 35/0068; A62B 35/0081; A62B 35/04

(57) ABSTRACT

A braking lever for a fall protection locking system is provided. The braking lever includes a first end defining a speed reduction curve that engages with a guide member of the fall protection locking system, a second end including a shock absorber that deforms during a fall instance, and a connecting portion extending between the first end and the second end. The connecting portion includes at least one hook that engages the second end with the connecting portion. A method of manufacturing a fall protection locking system is also provided.

### TECHNOLOGICAL FIELD

The present disclosure relates, generally, to fall protection systems and, more particularly, to fall protection locking systems.

### BACKGROUND

From recreation to survival devices, fall protection devices are instrumental in preserving the safety of users during traversal of uncertain conditions and heights. In order to operate effectively, protection devices must be able to freely travel along a guide member to allow freedom of movement, while also allowing for quick and effective activation of the braking mechanism without damaging the guide member. During a fall instance, a longer fall may lead to harvest of substantial kinetic energy and such kinetic energy may need to be absorbed effectively.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

According to an exemplary embodiment of the present disclosure, a braking lever for a fall protection locking system is provided. The braking lever includes a first end defining a speed reduction curve that engages with a guide member of the fall protection locking system, a second end including a shock absorber that deforms during a fall instance, and a connecting portion extending between the first end and the second end. The connecting portion includes at least one hook that engages the second end with the connecting portion.

In a preferred embodiment, the speed reduction curve is one of a logarithmic spiral curve, a hyperbolic curve, a parabolic curve, or an exponential curve.

In some embodiments, the first end further defines a first aperture to engage with a first pin defining a first pivot, and the first end rotates about the first pivot.

In some embodiments, the second end defines a second aperture configured to engage with a carabiner, the second aperture located vertically above the shock absorber with respect to a height of the braking lever.

In some embodiments, the second aperture and the shock absorber are in a same plane.

In some embodiments, the at least one hook is located between the shock absorber and the first end of the braking lever.

In some embodiments, the braking lever is made of one of cast iron or steel.

In some embodiments, the first end further defines a first arcuate surface extending from the speed reduction curve.

In some embodiments, a radius of curvature of the first arcuate surface is in a range of about 5 mm to about 6 mm and a radius of curvature of the speed reduction curve is in a range of about 19 mm to about 20 mm. In some embodiment, a distance between the first aperture at the first end and a second aperture at the second end is in a range of about 70 mm to about 80 mm.

According to another exemplary embodiment of the present disclosure, a fall protection locking system is provided. The fall protection locking system includes a housing defining a guide path to receive a guide member, where the housing is allowed to slide along the guide member. The fall protection locking system also includes a primary braking lever and a secondary braking lever. The primary braking lever is rotatably coupled in the housing and includes a first end to engage with the guide member, a second end having a shock absorber that deforms during a fall instance, and a connecting portion extending between the first end and the second end. The primary braking lever defines a speed reduction curve located between the first end thereof and the second end thereof. The connecting portion includes at least one hook to engage the first end with the connecting portion. The secondary braking lever is rotatably coupled in the housing and defines a second arcuate surface to engage with the guide member. The secondary braking lever functions independent of the primary braking lever.

In some embodiments, the secondary braking lever defines a third aperture to engage with a second pin defining a second pivot and the secondary braking lever rotates about the second pivot.

In some embodiments, the secondary braking lever is spring biased against rotation due to gravity when the fall protection locking system is stationary or subjected to minimum movement. In some embodiments, the primary braking lever is spring biased against rotation thereof.

In some embodiments, the secondary braking lever rotates into engagement with the guide member, due to change in the center of gravity of the secondary braking lever, during the fall instance.

In some embodiments, a diameter of the guide member is in a range of about 8 mm to about 10 mm.

According to yet another exemplary embodiment of the present disclosure, a method of manufacturing a fall protection locking system is provided. The method includes providing a housing defining a guide path that slidably receives a guide member, where the housing is allowed to slide along the guide member. The method further includes rotatably coupling a primary braking lever to the housing. The primary braking lever includes a first end including a velocity impending element that engages with the guide member, a second end including a shock absorber that deforms during a fall instance, and a connecting portion extending between the first end and the second end. The connecting portion includes at least one hook to engage the first end with the connecting portion. The method further includes rotatably coupling a secondary braking lever to the housing. The secondary braking lever defines a second arcuate surface to engage with the guide member. The secondary braking lever functions independent of the primary braking lever.

In a preferred embodiment, the speed reduction curve is one of a logarithmic spiral curve, a hyperbolic curve, a parabolic curve, or an exponential curve.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates an exemplary environment implementing a fall protection locking system, according to an aspect of the present disclosure;

FIG. 2 illustrates the fall protection locking system engaged with a guide member, according to an embodiment of the present disclosure:

FIG. 3A illustrates a primary braking lever of the fall protection locking system, according to one embodiment of the present disclosure:

FIG. 3B illustrates the primary braking lever, according to another embodiment of the present disclosure:

FIG. 4A illustrates an enlarged view of a first end of the primary braking lever in contact with the guide member, according to an aspect of the present disclosure:

FIG. 4B illustrates force vectors at the first end of the primary braking lever, according to an aspect of the present disclosure:

FIG. 5 illustrates movement of the primary braking lever during a fall instance, according to an aspect of the present disclosure:

FIG. 6 illustrates movement of a secondary braking lever during the fall instance, according to an aspect of the present disclosure:

FIG. 7 illustrates a first locking position of the fall protection locking system, according to an aspect of the present disclosure:

FIG. 8 illustrates a second locking position of the fall protection locking system, according to an aspect of the present disclosure:

FIG. 9 illustrates a third locking position of the fall protection locking system, according to an aspect of the present disclosure:

FIG. 10 illustrates a fourth locking position of the fall protection locking system, according to an aspect of the present disclosure; and

FIG. 11 is a flowchart of a method of manufacturing the fall protection locking system, according to an embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

Embodiments of the present disclosure are described more fully hereinafter with reference to the accompanying drawings, in which some, but not all, embodiments are shown. Indeed, various embodiments may be embodied in many different forms and should not be construed as limited to the embodiments set forth herein. Other embodiments, and modifications and improvements of the described embodiments, will occur to those skilled in the art and all such other embodiments, modifications and improvements are within the scope of the present invention. Features from one embodiment or aspect may be combined with features from any other embodiment or aspect in any appropriate combination. For example, any individual or collective features of method aspects or embodiments may be applied to apparatus, product or component aspects or embodiments and vice versa. Like numbers refer to like elements throughout.

The components illustrated in the figures represent components that may or may not be present in various embodiments of the present disclosure described herein, such that embodiments may include fewer or more components than those shown in the figures while not departing from the scope of the invention.

The phrases “in an embodiment,” “in some embodiments,” “according to one embodiment,” and the like generally mean that the particular feature, structure, or characteristic following the phrase may be included in at least one embodiment of the present disclosure or may be included in more than one embodiment of the present disclosure (importantly, such phrases do not necessarily refer to the same embodiment).

The present disclosure provides various examples of fall protection locking system to allow for effective operation during fall instances. Various embodiments herein allow for a reduction in force against a guide member, such that the guide member is less likely to be worn and/or break during the fall instance. During the fall instance (for example, an extended free fall), known fall arresting devices are fully reliant on a braking lever thereof to appropriately move into contact with the guide member in order to slow and/or stop the movement of the fall arresting device along the guide member. As such, any failure of the braking lever can be catastrophic. A position of the braking lever may allow a user to accidentally cause the braking lever to operate incorrectly by providing a force against the braking lever that disengages the braking lever from the guide member. Various embodiments of the present disclosure allow for a secondary, “anti-panic” locking feature that operates independently of the braking lever and also engages with the guide member during the fall instance. As discussed herein, the fall protection locking system may be used by humans but may also be used to raise and lower objects unless otherwise noted.

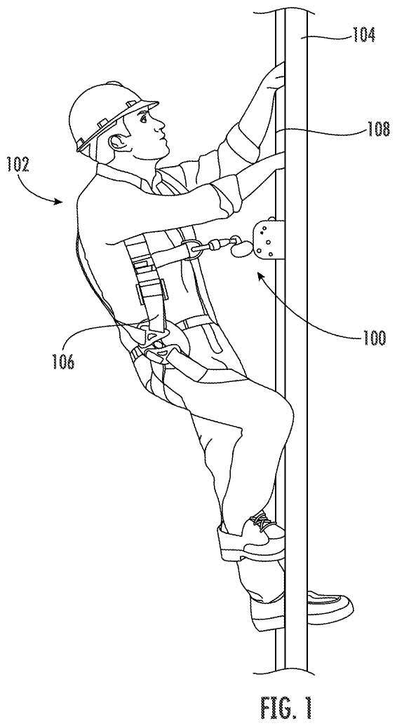

Referring to FIG. 1, an environment implementing a fall protection locking system 100 (hereinafter referred to as “the system 100”) is illustrated. FIG. 1 illustrates a user 102 climbing a ladder 104, where a safety harness 106 worn by the user 102 is coupled to the system 100 that is engaged with a guide member 108 (for example, a rope or a cable) extending along a length of the ladder 104. The safety harness 106 and the system 100 prevents the user 102 from falling off the ladder 104.

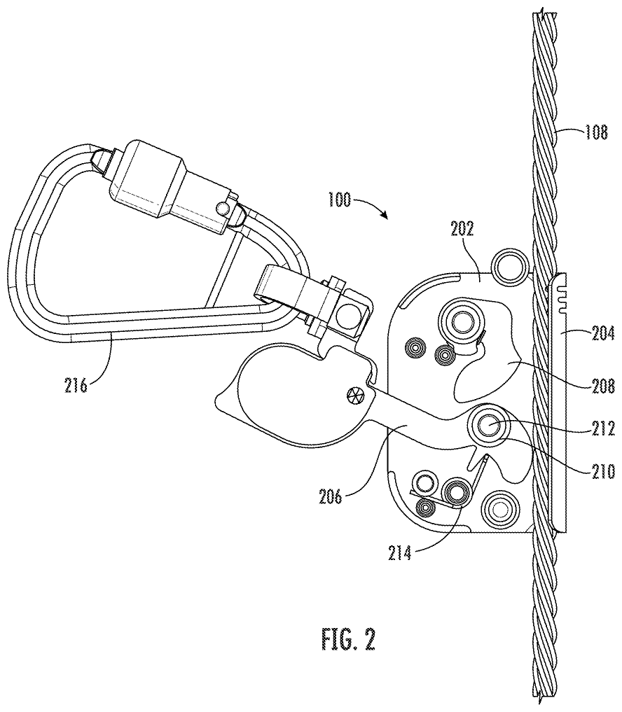

FIG. 2 illustrates the system 100 engaged with the guide member 108, according to an embodiment of the present disclosure. The system 100 includes a housing 202 having a proximal end and a distal end. The proximal end of the housing 202 is adapted to allow coupling with the safety harness 106 and hence is proximal to the user 102. The distal end of the housing 202 is opposite to the proximal end and includes a substantially curved portion 204 that defines a guide path (not particularly referenced with a numeral). The guide path is configured to receive the guide member 108. In some embodiments, the distal end may partially surround the guide member 108. In other embodiments, the distal end may completely surround the guide member 108. The guide member 108 may have a diameter in a range of about 8 mm to about 10 mm. As such, the curved portion 204 at the distal end of the housing 202 may have a radius of curvature based on the diameter of the guide member 108. For example, the housing 202 may include information engraved thereon indicating to the user 102 the diameter of the guide member 108 that the distal end can accommodate.

Accordingly, in some aspects of the present disclosure, different housings may be provided for different diameters of the guide member 108. Alternatively, in some embodiments, the housing 202 may include an adjustment mechanism to vary the curvature of the distal end of the housing 202 such that an inner surface of the curved portion 204 completely abuts the guide member 108. Although not particularly illustrated herein, the adjustment mechanism may include multiple components which, when actuated, causes the variation in the curvature of the curved portion 204. For example, the adjustment mechanism may include a screw rod and a nut arrangement together configured to cause curling of the distal end of the housing 202, and thereby increase a degree of contact between the inner surface of the curved portion 204 and the guide member 108. However, other such adjustment mechanism may become apparent to a person skilled in the art based on the description herein. As such, the same housing 202 may receive the guide member 108 having diameter of 8 mm or 10 mm. To this end, it will be understood that the curved portion 204 is configured to slidably receive the guide member 108. With such configuration, the housing 202 may be slid to a desired position along the guide member 108. Although the figures herein illustrate the curved portion 203 as extending continuously along a length of the housing 202, in some embodiments, non-continuous curved portions may be provided at the distal end of the housing 202.

The system 100 further includes a primary braking lever 206 (alternatively referred to as “the braking lever” in the present disclosure) and a secondary braking lever 208, each rotatably coupled in the housing 202. A cover plate (not shown) may be provided in the housing 202 to conceal the components of the system 100, although a portion of the primary braking lever 206 extends from the housing 202 as seen in FIG. 2. In an example, the cover plate may be secured to the housing 202 using one or more fasteners, such as bolts, rivets, and pins. In some embodiments, the housing 202 and the cover plate may constitute a unitary component of the system 100. The cover plate and the housing 202 together defines a hollow space therebetween configured to accommodate the components, such as the primary braking lever 206 and the secondary braking lever 208. In such arrangement, a thickness of the components may be predetermined so that the components may be accommodated between the cover plate and the housing 202.

It will be understood that a clearance may be provided between each component, the cover plate, and the housing 202 to allow rotation of the component. For example, the primary braking lever 206 may be rotatably coupled between the housing 202 and the cover plate, such that surfaces of the primary braking lever 206 do not contact surfaces of the cover plate and the housing 202. Such arrangement may be achieved based on a length of a coupling member, such as a pin, used for rotatably coupling the primary braking lever 206. Additionally, such arrangement also prevents wear of the primary braking lever 206. The secondary braking lever 208 may be similarly rotatably coupled between the cover plate and the housing 202. Since a planar portion (plate like structure) of the housing 202 and the curved portion 204 of the housing 202 define a receiving space, the primary braking lever 206 and the secondary braking lever 208 are described as “coupled in the housing 202”. In an alternate embodiment, other structures of housing may be apparent to the person skilled in the art, where the primary braking lever 206 and the secondary braking lever 208 may be “coupled to” or “coupled on” such housing.

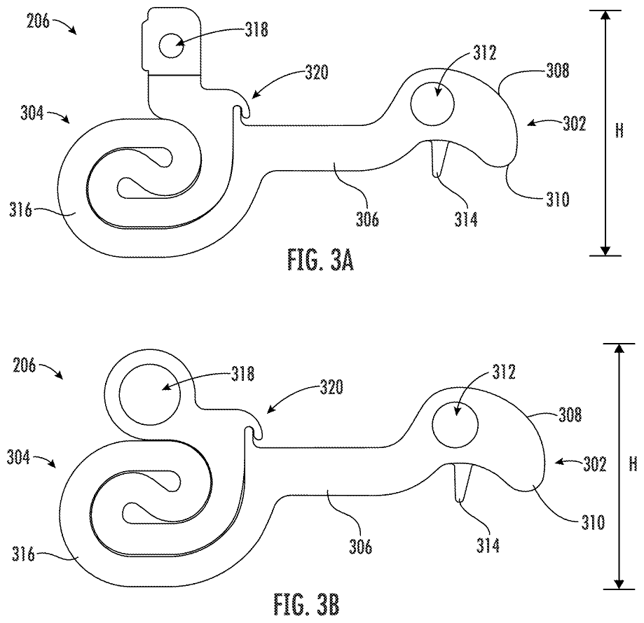

FIG. 3A and FIG. 3B illustrate embodiments of the primary braking lever 206. FIG. 3A and FIG. 3B are described in conjunction with FIG. 1 and FIG. 2. The primary braking lever 206 includes a first end 302, a second end 304, and a connecting portion 306 extending between the first end 302 and the second end 304. The first end 302 is configured to engage with the guide member 108. More particularly, the first end 302 defines a speed reduction curve 308 configured to engage with the guide member 108. In an embodiment, the speed reduction curve 308 may be one of a logarithmic spiral curve, a hyperbolic curve, a parabolic curve, or an exponential curve. For instance, the speed reduction curve 308 may be a logarithmic spiral curve, wherein the term “logarithmic spiral curve” refers to a curve for which an angle between a tangent and a radius is a constant. In some embodiments, a radius of curvature of the speed reduction curve 308 is in a range of about 19 mm to about 20 mm. The first end 302 further defines a first arcuate surface 310 extending from the speed reduction curve 308. In some embodiments, a radius of curvature of the first arcuate surface 310 is in a range of about 5 mm to about 6 mm. The speed reduction curve 308 and the first arcuate surface 310 together defines a continuous curved surface at the first end 302 of the primary braking lever 206. In an aspect, a point at which the speed reduction curve 308 transitions into the first arcuate surface 310 may be referred to as the first end 302 of the primary braking lever 206. As such, the speed reduction curve 308 is located between the first end 302 and the second end 304. In an embodiment, the speed reduction curve 308 may be defined in a separate member configured to be attached to the first end 302 of the primary braking lever 206 to engage with the guide member 108.

In some embodiments, the primary braking lever 206 may be made of one of cast iron or steel. In other embodiments, the primary braking lever 206 may be made of other metals or alloys thereof. The first end 302 defines a first aperture 312 configured to engage with a first pin 210 defining a first pivot 212 (see FIG. 2), and the first end 302 is configured to rotate about the first pivot 212. The first end 302 also includes an extension 314 configured to retain the first end 302 biased against a force of a spring 214 (see FIG. 2). As such, the primary braking lever 206 is spring biased against rotation thereof.

The second end 304 of the primary braking lever 206 includes a shock absorber 316 configured to deform during a fall instance. As used herein, the term “fall instance” may include an instance in which a predetermined force is achieved based on the user 102 falling from the ladder 104. In some embodiments, the system 100 may be designed based on a maximum falling speed of the user 102 during operation. The shock absorber 316 has a curled configuration. The second end 304 also defines a second aperture 318 configured to engage with a carabiner 216 (see FIG. 2) and located vertically above the shock absorber 316 with respect to a height “H” of the primary braking lever 206. The second aperture 318 may be provided as one of illustrated in FIG. 3A or FIG. 3B. In an embodiment, a distance between the first aperture 312 and the second aperture 318 may be in a range of about 70 mm to about 80 mm. The carabiner 216 may be coupled to the second aperture 318 using various means, such as fasteners, known to a person skilled in the art. In some embodiments, the second aperture 318 and the shock absorber 316 are in a same plane. In some embodiments, the second aperture 318 and the shock absorber 316 may be located in different planes. In some embodiments, the second aperture 318 may be defined in an extension of the shock absorber 316, as illustrated in FIG. 3A and FIG. 3B. Further, the connecting portion 306 includes at least one hook 320 configured to engage the second end 304 with the connecting portion 306. In the illustrated embodiments, the second end 304 includes a first finger-like projection and an end of the connecting portion 306 proximal to the second end 304 includes a second finger-like projection. An engagement of the first finger-like projection and the second finger-like projection is referred to here as “the at least one hook”. In some embodiments, the primary braking lever 206 may include multiple such hooks. Although the connecting portion 306 is illustrated as a linear portion, in some embodiments the connecting portion 306 may be non-linear. For example, a shape and thickness of the connecting portion 306 may be varied along a length thereof. However, the thickness of the connecting portion 306 may be predetermined based on the clearance between the cover plate and the housing 202 of the system 100. In some embodiments, the primary braking lever 206 may have a constant thickness from the first end 302 thereof to the second end 304 thereof. In other embodiments, the first end 302 may have a thickness greater than the second end 304. To this end, it will be apparent to the person skilled in the art to vary the thickness of portions of the primary braking lever 206 along a length thereof, without deviating from the scope of the present disclosure.

According to an aspect of the present disclosure, the at least one hook 320 is located between the shock absorber 316 and the first end 302 of the primary braking lever 206. The at least one hook 320 is also configured to disengage the second end 304 from the connecting portion 306 during the fall instance, when the predetermined force during the fall instance is greater than an engagement force at the at least one hook 320 that holds the second end 304 and the connecting portion 306 together.

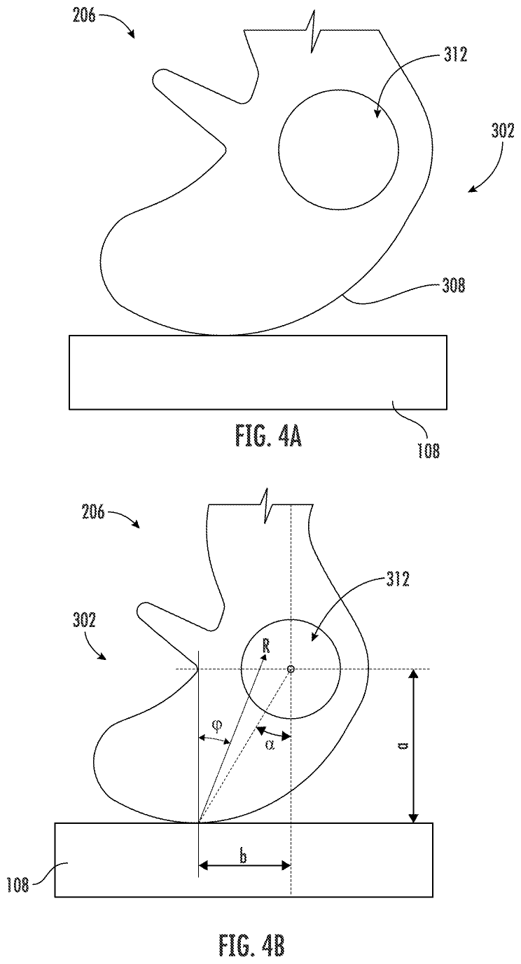

FIG. 4A illustrates an enlarged view of the first end 302 of the primary braking lever 206 in contact with the guide member 108. As described earlier, the first end 302 defines the speed reduction curve 308, which is preferably the logarithmic spiral curve as per the present disclosure. Use of the logarithmic spiral curve results in same effect at contact between different points along the curvature and the guide member 108, unlike conventionally known braking members. As such, the user 102 may not experience a sudden impact during the fall instance. FIG. 4B illustrates force vectors at the first end 302. In FIG. 4B, “a” indicates a distance between the guide member 108 and the center of the first aperture 312; and “b” indicates a distance along the guide member 108 and measured between a point of contact and the center of the first aperture 312. As the primary braking lever 206 rotates about the center of the first aperture 312 (or, specifically, the first pivot 212), multiple points of contact may be obtained between the speed reduction curve 308 and the guide member 108. In order to have a same performance of gripping against the guide member 108 and stop sliding the system 100 during the fall instance for various diameters of the guide member 108, it is required to have a resulting reaction force under a same angle (such as “α”). The angle “α” may be at least equal to a friction angle “φ” to minimize bounce off. Unwanted engagements between the speed reduction curve 308 and the guide member 108 may be encountered when the angle “α” is greater than a predetermined value.

$$α = arctan ( b / a )$$

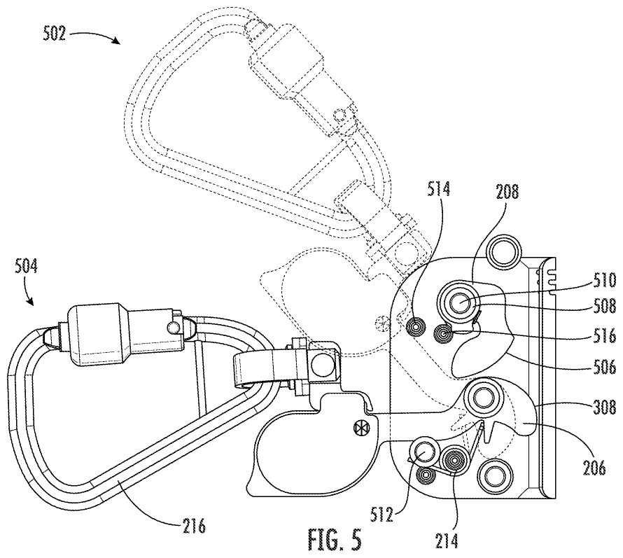

FIG. 5 illustrates a movement of the primary braking lever 206 during the fall instance. To this end, it will be understood that the system 100 may be actuated between an unlocked position (generally indicated by reference numeral 502) and a locked position (generally indicated by reference numeral 504). As used herein, the term “unlocked position” refers to a condition where the system 100 travels along the guide member 108 with minimal resistance. The term “locked position” indicates engagement between the guide member 108 and at least one of the primary braking lever 206 and the secondary braking lever 208, to restrict and/or stop travel of the system 100 along the guide member 108 during the fall instance. For the purpose of brevity, the guide member 108 is not illustrated in FIG. 5 to FIG. 10. For the purpose of engaging the housing 202 with the guide member 108, the primary braking lever 206 may be rotated to the unlocked position 504 to allow the guide member 108 to be received into the guide path defined by the curved portion 204. When released, the primary braking lever 206 may settle at a position where the speed reduction curve 308 abuts the guide member 108.

The secondary braking lever 208 defines a second arcuate surface 506 configured to engage with the guide member 108. The secondary braking lever 208 is located adjacent to the primary braking lever 206 along a length of the housing 202 and is configured independent from the primary braking lever 206. For the purpose of coupling, the secondary braking lever 208 defines a third aperture (not shown) configured to engage with a second pin 508 defining a second pivot 510. The third aperture is formed similar to the first aperture 312 and configured to receive the second pin 508 therethrough. The second pin 508 aids to rotatably couple the secondary braking lever 208 in the housing 202. That is, the secondary braking lever 208 is configured to rotate about the second pivot 510. In some embodiments, ends of the second pin 508 may be attached to the housing 202 and the cover plate to allow rotation of the secondary braking lever 208 therebetween. The secondary braking lever 208 is located distant from the primary braking lever 206, such that rotation of each of the secondary braking lever 208 and the primary braking lever 206 do not obstruct the other.

The unlocked position 502 may indicate a maximum position that the primary braking lever 206 be rotated to when the user 102 is climbs the ladder 104. In an embodiment, the housing 202 may include a first stopper 512 to restrict further rotation of the primary braking lever 206 when the user climbs the ladder 104. In the unlocked position 502, the first end 302 of the primary braking lever 206 may not contact the guide member 108, thereby allowing smooth travel of the system 100 along the guide member 108 based on the climbing of the user 102. The climbing activity of the user 102, develops a pull force on the primary braking lever 206, thereby owing the rotation of the primary braking lever 206 to the unlocked position 502. As such, rotation of the primary braking lever 206 during the climbing activity of the user 102 takes place against the biasing force of the spring 214. During the fall instance, the primary braking lever 206 moves from the unlocked position 502 to the locked position 504, where the first end 302 of the primary braking lever 206 rotates towards the guide member 108. Additionally, during the fall instance, the biasing force of the spring 214 aids faster rotation of the first end 302 about the first pivot 212. Particularly, with aid of the speed reduction curve 308, the first end 302 pushes the guide member 108 against the curved portion 204, thereby locking the system 100 instantly and preventing further fall of the user 102. In other words, the speed reduction curve 308 causes reduction in velocity of the system 100 during the fall instance. As such, the speed reduction curve 308 is alternatively referred to as “the velocity impending element” in the present disclosure. The housing 202 may include a second stopper 514 to prevent movement of the primary braking lever 206 beyond the locked position 504 during the fall instance. In an embodiment, the velocity impending element is coupled to the first end 302 to provide an effect offered by the speed reduction curve 308 as discussed herein. That is, the velocity impending element may be an external component configured to retrofit at the first end 302 of the primary braking lever 206. In order to achieve such retrofit, the first end 302 may be altered in a manner known to the person skilled in the art to achieve the effect offered by the speed reduction curve 308 as discussed herein. In some embodiments, the velocity impending element may form a continuous arcuate surface at the first end 302 as illustrated herein, when coupled to the first end 302.

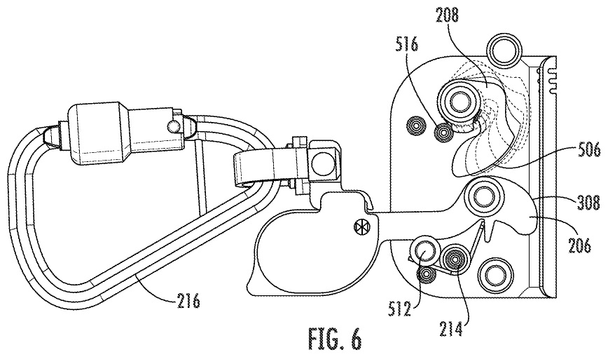

FIG. 6 illustrates movements of the secondary braking lever 208 during the fall instance. In an embodiment, the secondary braking lever 208 may be an inertial component of the system 100. For example, the secondary braking lever 208 may be biased by a force of a spring 516 such that the force of gravity holds the secondary braking lever 208 in place during operations, such as the climbing activity of the user 102 or when the system 100 is subjected to minimum movement. As used herein, the term “minimum movement” includes instances (and forces involved thereof) when the system 100 is being coupled to the user 102. That is, the secondary braking lever 208 is spring biased against rotation due to the gravity when the system 100 is stationary or subjected to the minimum movement. As used herein, the term “stationary” refers to an instance when the system 100 is not coupled to the user 102 or when no force is incident on the system 100.

The spring 516 is configured to counteract the force of gravity on the secondary braking lever 208. As such, in an instance the system 100 is not moving or moving slowly, the force due to gravity may be counteracted by the spring 516, such that the secondary braking lever 208 has minimal to no rotational movement. During the fall instance, the force of gravity decreases on the secondary braking lever 208 and, as an effect, the force from the spring 516 has little or no counter force due to gravity. As a result, the secondary braking lever 208 is allowed to rotate in the counterclockwise direction, such that the second arcuate surface 506 of the secondary braking lever 208 contacts and urges against the guide member 108. In an aspect, a center of gravity of the secondary braking lever 208 may be proximal the second arcuate surface 506. During the fall instance, the secondary braking lever 208 is configured to rotate into engagement with the guide member 108, due to change in the center of gravity of the secondary braking lever 208. Due to the counterclockwise direction of the secondary braking lever 208, an upward force is incident on the guide member 108 besides a stopping force.

Engagement of the second arcuate surface 506 of the secondary braking lever 208 with the guide member 108 in addition to the engagement of the speed reduction curve 308 of the primary braking lever 206 provides additional brake force to at least arrest movement of the system 100 at least instantly along the guide member 108 during the fall instance. As such, the secondary braking lever 208 may be independent of the primary braking lever 206. As a result of such configuration, the secondary braking lever 208 may provide the stopping force in an instance in which the primary braking lever 206 does not function correctly.

In some embodiments, each of the second arcuate surface 506 and the speed reduction curve 308 may be machined in a manner to develop maximum friction force with the guide member 108 during the fall instance, thereby preventing further sliding of the system 100 along the guide member 108. In some embodiments, the second arcuate surface 506 may defines, for example, grooves to increase the stopping force. In some embodiments, the primary braking lever 206 and the secondary braking lever 208 may be made from grade-5 stainless steel. In other embodiments, the primary braking lever 206 and the secondary braking lever 208 may be made from, but are not limited to, 1.4571 stainless steel (a weldable austenitic stainless steel), X6CrNiMoTil7-12-2 (an austenitic stainless steel that offers an excellent corrosion resistance due to the addition of molybdenum), 316Ti (a titanium stabilized version of 316 molybdenum-bearing austenitic stainless steel), 320S31 (austenitic special steel), or a combination thereof.

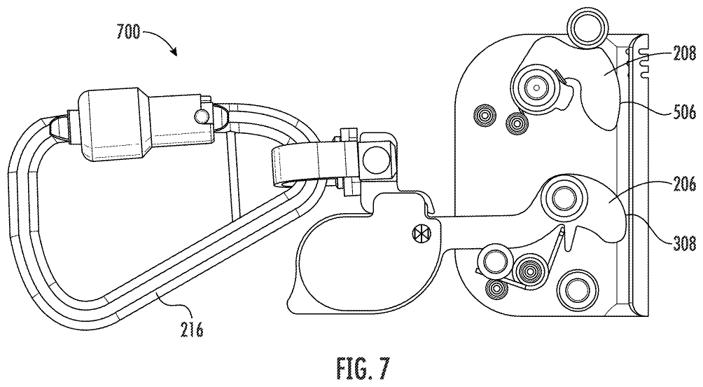

FIG. 7 illustrates a first locking position 700 of the system 100. In the first locking position 700, the second arcuate surface 506 of the secondary braking lever 208 and the speed reduction curve 308 of the primary braking lever 206 are engaged with the guide member 108, thereby stopping movement of the system 100 along the guide member 108 during the fall instance. As described earlier, the primary braking lever 206 and/or the secondary braking lever 208 may be activated during an instance of a certain force (for example, the user 102 falling at a certain speed) has been reached. In some embodiments, an activation force for the primary braking lever 206 and/or the secondary braking lever 208 may be based on a design of each component.

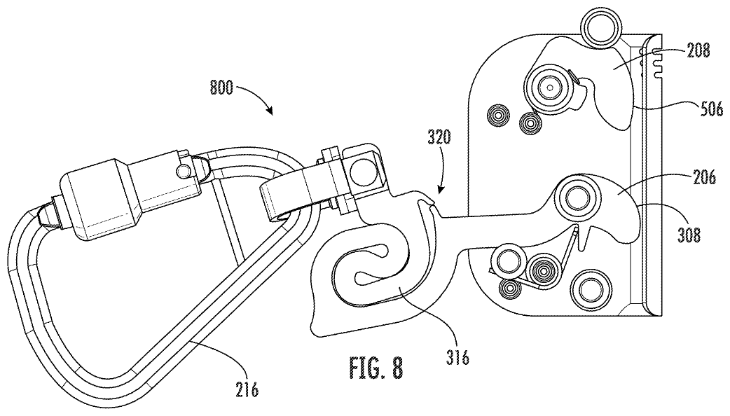

FIG. 8 illustrates a second locking position 800 of the system 100. In the second locking position 800, the second arcuate surface 506 of the secondary braking lever 208 and the speed reduction curve 308 of the primary braking lever 206 remain engaged with the guide member 108. However, during the fall, the user 102 experiences a certain momentum of fall developed from the instance the user 102 falls from the ladder 104. With the braking offered by the primary braking lever 206 and the secondary braking lever 208, such momentum of fall may not be instantly nullified. When a force of fall corresponding to such momentum exceeds a threshold, the at least one hook 320 may be urged to decouple. As used herein with respect to the hook 320, the term “threshold” refers to the force required to retain the hook 320 in a coupled state. Alternatively, the term “threshold” may be understood as the force required to retain the first finger-like projection and the second finger-like projection of the hook 320 in an engaged condition. FIG. 8 illustrates an instance when the force of fall is greater than the threshold force on the hook 320, thereby causing decoupling of the hook 320. During the fall instance, the force of fall associated with carabiner 216 causes a region around the second aperture 318 to exert at pull force at the hook 320, thereby forcibly urging the hook 320 to decouple. Since the second aperture 318 is located adjacently above the shock absorber 316 with respect to the height “H” of the primary braking lever 206, the shock absorber 316 is configured to dampen any extreme forces arising from the fall instance.

In such an instance, the decoupling of the hook 320 may indicate that the system 100 withstood a certain force of fall and requires the system 100 to be replaced. In some embodiments, as shown, the shock absorber 316 may define a double-spiral deformation shape. As such, the double-spiral deformation shape may allow absorption of maximum energy during the fall instance with minimal weight thereof based on the material used. In an aspect, the shock absorber 316 may improve comfort during normal usage, as well as allow for implementation of stronger spring for faster reaction to the fall instance. However, in other embodiments, the shock absorber 316 may have various shapes albeit with few variations to the configuration described herein.

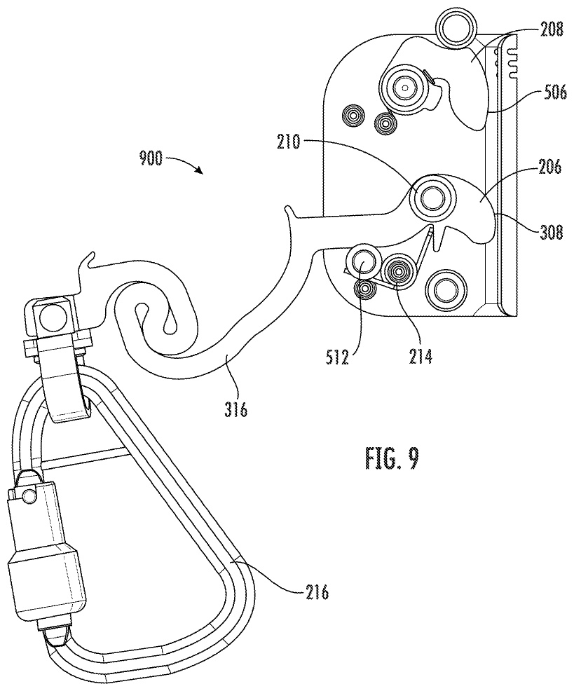

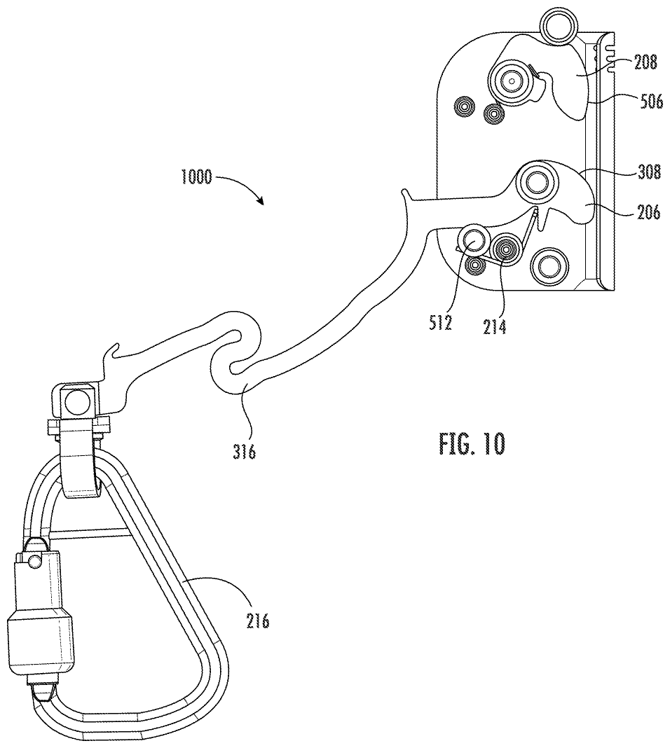

FIG. 9 illustrates a third locking position 900 of the system 100. In the third locking position 900, the second arcuate surface 506 of the secondary braking lever 208 and the speed reduction curve 308 of the primary braking lever 206 remain engaged with the guide member 108. Upon decoupling of the hook 320, the shock absorber 316 partially unwound while absorbing the force of fall. The first stopper 512 prevents further rotation of the primary braking lever 206 during the fall instance and may, in addition to the first pin 210, absorb a pull force incident on the primary braking lever 206 due to the weight of the user 102. FIG. 10 illustrates a fourth locking position 1000 of the system 100, where the shock absorber 316 further unwinds to absorb the force of fall and prevent any shock from being transmitted to the user 102. The first, second, third, and fourth locking positions described and illustrated herein are merely for clarity in the description. During the fall instance, the system 100 does not provide individual locking positions described herein. Instead, during the fall instance, the person skilled in the art may anticipate overlap of two or more locking positions described herein.

To this end, the present disclosure provides an efficient system 100 to protect the user 102 during the fall instance. The speed reduction curve 308 of the primary braking lever 206 provides same performance for an 8 mm cable and a 10 mm cable, which was a challenge in the known fall protection systems. The system 100 is configured to minimize a locking distance and reduce energy absorbed by the shock absorber 316, as compared to the known fall protection systems. Since the energy that needs to be absorbed by the shock absorber 316 is reduced, structure and size of the shock absorber 316 may also be reduced, thereby resulting in reduced cost of the component. As such, an overall weight of the system 100 may also be reduced. In one aspect, the shock absorber 316 of the present disclosure weighs about 77% of corresponding shock absorbers used in known fall protection systems. In another aspect, the system 100 of the present disclosure weighs in a range of about 250 grams to about 270 grams as compared to known fall protection systems which may weight about 325 grams or more.

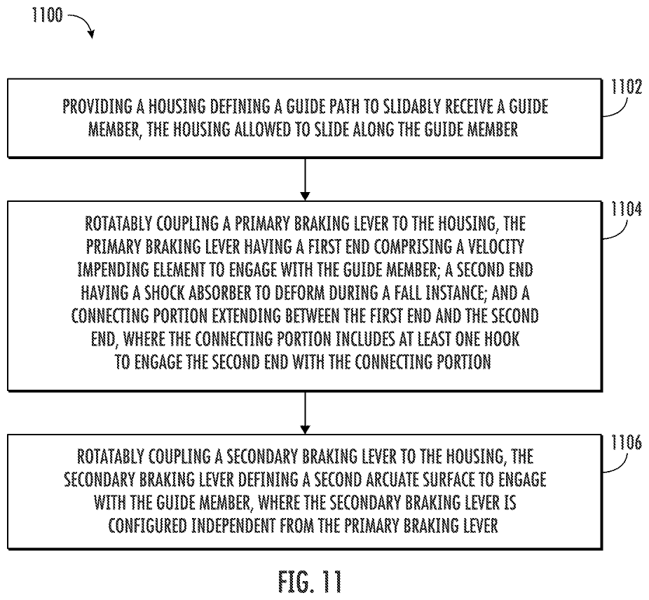

FIG. 11 is a flowchart of a method 1100 of manufacturing the system 100. The method 1100 is described is conjunction with FIG. 1 through FIG. 10. Steps of the method 1100 described herein may alternatively represent a method of assembling the system 100. At step 1102, the method 1100 includes providing the housing 202. The housing 202 defines the guide path configured to slidably receive the guide member 108. As such, the housing 202 is configured to slide along the guide member 108.

At step 1104, the method 1100 includes rotatably coupling the primary braking lever 206 to the housing 202. The primary braking lever 206 includes the first end 302 including a velocity impending element (such as the speed reduction curve 308) configured to engage with the guide member 108: the second end 304 including the shock absorber 316 configured to deform during the fall instance; and the connecting portion 306 extending between the first end 302 and the second end 304. The connecting portion 306 includes the at least one hook 320 configured to engage the second end 304 with the connecting portion 306. In some embodiments, the speed reduction curve 308 is one of a logarithmic spiral curve, a hyperbolic curve, a parabolic curve, or an exponential curve.

At step 1106, the method 1100 includes rotatably coupling the secondary braking lever 208 to the housing 202. The secondary braking lever 208 defines the second arcuate surface 506 configured to engage with the guide member 108. The secondary braking lever 208 is configured independent from the primary braking lever 206.

Many modifications and other embodiments of the present disclosure set forth herein will be apparent to the person skilled in the art to which the present disclosure pertain having the benefit of the teachings presented in the foregoing descriptions and the associated drawings. Therefore, it is to be understood that the present disclosure is not limited to the specific embodiments disclosed herein, and that the modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense and should not be construed as limiting.

What is claimed is:

1. A braking lever for a fall protection locking system, the braking lever comprising:
a first end defining a speed reduction curve configured to engage with a guide member of the fall protection locking system;
a second end comprising a shock absorber configured to deform during a fall instance; and
a connecting portion extending between the first end and the second end, the connecting portion comprising at least one hook configured to engage the second end with the connecting portion.

2. The braking lever of claim 1, wherein the speed reduction curve is one of a logarithmic spiral curve, a hyperbolic curve, a parabolic curve, or an exponential curve.

3. The braking lever of claim 1, wherein the first end further defines a first aperture configured to engage with a first pin defining a first pivot and configured to rotate about the first pivot.

4. The braking lever of claim 3, wherein the second end defines a second aperture configured to engage with a carabiner, the second aperture located vertically above the shock absorber with respect to a height of the braking lever.

5. The braking lever of claim 4, wherein the second aperture and the shock absorber are in a same plane.

6. The braking lever of claim 1, wherein the at least one hook is located between the shock absorber and the first end of the braking lever.

7. The braking lever of claim 1, wherein the braking lever is made of one of cast iron or steel.

8. The braking lever of claim 1, wherein the first end further defines a first arcuate surface extending from the speed reduction curve.

9. The braking lever of claim 8, wherein a radius of curvature of the first arcuate surface is in a range of about 5 mm to about 6 mm.

10. The braking lever of claim 1, wherein a radius of curvature of the speed reduction curve is in a range of about 19 mm to about 20 mm.

11. The braking lever of claim 2, wherein a distance between the first aperture at the first end and a second aperture at the second end is in a range of about 70 mm to about 80 mm.

12. A fall protection locking system comprising:
a housing defining a guide path configured to receive a guide member, wherein the housing is configured to slide along the guide member;
a primary braking lever rotatably coupled in the housing, the primary braking lever comprising:
a first end configured to engage with the guide member;
a second end comprising a shock absorber configured to deform during a fall instance, wherein the primary braking lever defines a speed reduction curve located between the first end thereof and the second end thereof; and
a connecting portion extending between the first end and the second end, the connecting portion comprising at least one hook configured to engage the second end with the connecting portion; and
a secondary braking lever rotatably coupled in the housing and defining a second arcuate surface configured to engage with the guide member, wherein the secondary braking lever is configured independent from the primary braking lever.

13. The fall protection locking system of claim 12, wherein the speed reduction curve is one of a logarithmic spiral curve, a hyperbolic curve, a parabolic curve, or an exponential curve.

14. The fall protection locking system of claim 12, wherein the secondary braking lever defines a third aperture configured to engage with a second pin defining a second pivot, wherein the secondary braking lever is configured to rotate about the second pivot.

15. The fall protection locking system of claim 14, the secondary braking lever is spring biased against rotation due to gravity when the fall protection locking system is stationary or subjected to minimum movement.

16. The fall protection locking system of claim 15, wherein the secondary braking lever is configured to rotate into engagement with the guide member, due to change in the center of gravity of the secondary braking lever, during the fall instance.

17. The fall protection locking system of claim 12, wherein a diameter of the guide member is in a range of about 8 mm to about 10 mm.

18. The fall protection locking system of claim 12, wherein the primary braking lever is spring biased against rotation thereof.

19. Method of manufacturing a fall protection locking system, the method comprising:
providing a housing, wherein the housing defines a guide path configured to slidably receive a guide member, the housing configured to slide along the guide member;
rotatably coupling a primary braking lever to the housing, the primary braking lever comprising a first end comprising a velocity impending element configured to engage with the guide member; a second end comprising a shock absorber configured to deform during a fall instance; and a connecting portion extending between the first end and the second end, wherein the connecting portion comprises at least one hook configured to engage the second end with the connecting portion; and
rotatably coupling a secondary braking lever to the housing, the secondary braking lever defining a second arcuate surface configured to engage with the guide member, wherein the secondary braking lever is configured independent from the primary braking lever.

20. The method of claim 12, wherein the speed reduction curve is one of a logarithmic spiral curve, a hyperbolic curve, a parabolic curve, or an exponential curve.
